(19) United States
(12) Patent Application Publication
(10) Pub. No.: US 2010/0294733 A1
(43) Pub. Date: Nov. 25, 2010

(54) CHASSIS FOR COUPLING A STACK OF TWO OR MORE TELECOMMUNICATIONS MODULES TO A FRONT SIDE OF A RACKING SYSTEM

(75) Inventors: Kevin James Truskett, Kincumber (AU); Malcolm Bruce Brear, Empire Bay (AU)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 12/785,005

(22) Filed: May 21, 2010

(30) Foreign Application Priority Data
May 21, 2009 (AU) 2009202010

(51) Int. Cl. A47B 96/06; A47B 96/00; F16B 35/00; F16M 13/02

(52) U.S. Cl. 211/26; 248/220.21; 411/393; 248/222.14

(57) ABSTRACT

A chassis for coupling a stack of two or more telecommunications modules to a front side of a racking system, including a bracket having a back member shaped to extend across a back side of said stack of modules, and side members extending from opposite end sections of the back member towards a front side of the modules; module fasteners for coupling respective ones of said modules to respective sections of the back member; and a rack fastener for coupling the bracket to the racking system, wherein said module fasteners facilitate individual stacking of the modules to said respective sections of the back member one on top of another.

This application claims benefit of Serial No. 2009202010, filed 21 May 2009 in Australia and which application is incorporated herein by reference. To the extent appropriate, a claim of priority is made to the above disclosed applications.

### TECHNICAL FIELD OF THE INVENTION

The present invention relates to a chassis for coupling a stack of two or more telecommunications modules to a front side of a racking system; and a chassis for coupling two stacks of two or more telecommunications modules to a front side of a racking system.

### BACKGROUND OF THE INVENTION

Installation of telecommunication modules in racking systems has preciously involved the stacking of modules, one on top of the other. In doing so, the accumulated weight of the stack of modules has lead to modules positioned lower in the stack being crushed, or otherwise damaged. It is generally undesirable to store telecommunication modules in a racking system under excessive compressive loads. Further, in such an arrangement, it may be generally inconvenient and impractical to remove a module positioned lower in the stack due to the accumulated weight of superiorly stacked modules.

Chassis have previously been designed for mounting telecommunications modules in a racking system. For example, a chassis has previously been developed to house telecommunication modules with Bayonet Neill-Concelman (BNC) connectors, where the modules are fitted and removed from their chassis from the back of the racking system. In doing so, the BNC connectors face the rear of the racking system. It may not always by convenient or safe to fit and remove telecommunication modules from the rear of the racking system. For example, in a telecommunication installation where RF splitter modules are mounted in metal chassis, the RF modules may need to be fitted and removed from their metal chassis entirely from the front of the racking system to avoid human contact with live 240v at the rear of the racking system.

It is generally desirable to overcome or ameliorate one or more of the above mentioned difficulties, or at least provide a useful alternative.

### SUMMARY OF THE INVENTION

In accordance with one aspect of the invention, there is provided a chassis for coupling a stack of two or more telecommunications modules to a front side of a racking system, including:
(a) a bracket having a back member shaped to extend across a back side of said stack of modules, and side members extending from opposite end sections of the back member towards a front side of the modules;
(b) module fasteners for coupling respective ones of said modules to respective sections of the back member; and
(c) a rack fastener for coupling the bracket to the racking system,
   wherein said module fasteners facilitate individual stacking of the modules to said respective sections of the back member one on top of another.

Preferably, the rack fastener includes two flanges extending in parallel, in opposite directions, from distal ends of the side members of the bracket.

Preferably, the module fasteners include fixing screws for coupling flanges extending from back sections of the modules over the back member to corresponding clinch nuts secured to the back member.

Preferably, the fixing screws are elongate and extend from the back member towards the front side of the modules.

Preferably, the module fasteners facilitate inverted coupling of the modules, about respective horizontal axes, to said respective sections of the back member.

Preferably, the chassis inhibits transfer of external forces to said stack of modules coupled thereto.

Preferably, Bayonet Neill-Concelman connectors connected to the front side of the modules are accessible for connection from the front side of the racking system.

Preferably, the modules are Radio Frequency modules.

In accordance with another aspect of the invention, there is provided a chassis for coupling two stacks of two or more telecommunications modules to a front side of a racking system, including:
(a) a bracket having a back member shaped to extend across back sides of both laterally displaced stacks of modules, and side members extending from opposite end sections of the back member towards a front side of the modules;
(b) module fasteners for coupling respective ones of said modules to respective sections of the back member; and
(c) a rack fastener for coupling the side members of the bracket to the racking system,
   wherein for each stack of said stacks, said module fasteners facilitate individual stacking of the modules to said respective sections of the back member one on top of another.

In accordance with yet another aspect of the invention, there is provided a chassis for coupling two stacks of two or more telecommunications modules to a front side of a racking system, including:
(a) a bracket having a back member shaped to extend across back sides of both laterally displaced stacks of modules, and side members extending from opposite ends of the back member towards a front side of the modules;
(b) module fasteners for coupling respective ones of said modules to respective sections of the back member;
(c) a support bracket coupled between the stacks of modules, including lateral support members for engaging and at least partially supporting lateral sections of the modules; and
(d) a rack fastener for coupling distal ends of the side members of the bracket to the racking system,
   wherein for each stack of said stacks, said module fasteners facilitate individual coupling of the modules to said respective sections of the back member one on top of another.

Preferably, the lateral support members are shaped to at least partially receive lateral rail members extending between front and back sides of the modules.

Preferably, the lateral support members locate modules in positions for engagement with said respective sections of the back member.

Preferably, the lateral support members are generally “U” shaped.

Preferably, the module fasteners include fixing screws for coupling flanges extending from back sections of modules over the back member to corresponding clinch nuts secured to the back member.

Preferably, the fixing screws are elongate and extend from the back member towards the front side of the modules.

Preferably, the module fasteners facilitate inverted coupling of the modules, about respective horizontal axes, to said respective sections of the back member.

Preferably, the chassis inhibits transfer of external forces to said stacks of modules when coupled thereto.

Preferably, Bayonet Neill-Concelman connectors connected to the front side of the modules are accessible for connection from the front side of the racking system.

Preferably, the modules are Radio Frequency modules.

### BRIEF DESCRIPTION OF THE DRAWINGS

Preferred embodiments of the present invention are hereafter described, by way of non-limiting example only, with reference to the accompanying drawing in which:

FIG. 1 is a front perspective view of a chassis for coupling two stacks of telecommunications modules to a racking system;

FIG. 2 is a front view of the chassis shown in FIG. 1;

FIG. 3 is a front view of the chassis shown in FIG. 1 coupled to a racking system and telecommunications modules;

FIG. 4 is a section view of the chassis shown in FIG. 3 through the line A-A;

FIG. 5 is a section view of the chassis shown in FIG. 3 through the line B-B;

FIG. 6 is a front perspective view of another chassis for coupling two stacks of telecommunications modules to a racking system;

FIG. 7 is a partially exploded view of the chassis shown in FIG. 6;

FIG. 8 is a front view of the chassis shown in FIG. 6 coupled to a racking system and telecommunications modules;

FIG. 9 is a section view of the chassis shown in FIG. 8 through the line C-C;

FIG. 10 is a section view of the chassis shown in FIG. 8 through the line D-D;

FIG. 11 is view of the chassis shown in FIG. 10 arranged in another condition of use; and

FIG. 12 is a section view of the chassis shown in FIG. 8 through the line E-E.

### DETAILED DESCRIPTION OF PREFERRED EMBODIMENTS OF THE INVENTION

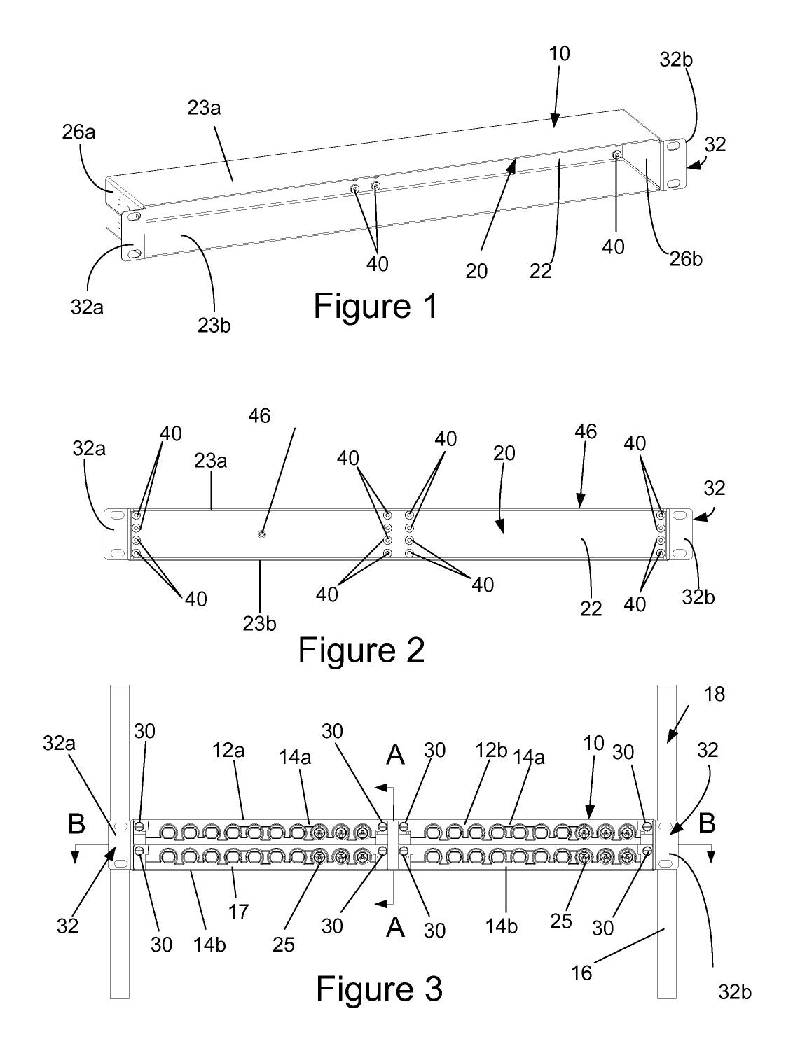

The chassis 10 shown in FIGS. 1 to 5 is used to couple two stacks 12a, 12b of two telecommunications modules 14a, 14b to a front side 16 of a racking system 18. As particularly shown in FIG. 5, the chassis 10 includes a bracket 20 having a back member 22 shaped to extend across back sides 24 of both laterally displaced stacks 12a, 12b of modules 14a, 14b, and side members 26a, 26b extending from opposite end sections 28a, 28b of the back member 22 towards the front side 17 of the modules 14a, 14b. The chassis 10 also includes module fasteners 30 for coupling respective ones of the modules 14a, 14b to respective sections of the back member 22; and a rack fastener 32 for coupling the side members 26a, 26b of the bracket 20 to the racking system 18. For each stack 12a, 12b of modules 14a, 14b, the module fasteners 30 facilitate individual stacking of the modules 14a, 14b to their respective sections of the back member 22 one on top of another.

The bracket 22 of the chassis also includes top and bottom housing members 23a, 23b extending between common top sides of the back member 22 and the side members 26a, 26b, and common bottom sides of the back member 22 and the side members 26a, 26b respectively. The chassis 10 thereby inhibits transfer of external forces to the stacks 12a, 12b of modules 14a, 14b coupled thereto. Bayonet Neill-Concelman connectors 25 connected to the front side 17 of the modules 14a, 14b are accessible for connection from the front side 16 of the racking system 18. The modules 14a, 14b are preferably Radio Frequency modules.

The racking system 18 is preferably a 19 inch rack.

The rack fastener 32 includes two flanges 32a, 32b extending in parallel, in opposite directions, from distal ends 34a, 34b of the side members 26a, 26b of the bracket 20. The flanges 32a, 32b are generally co-planar with the front side 17 of the modules 14a, 14b when the modules 14a, 14b are coupled to the chassis 10.

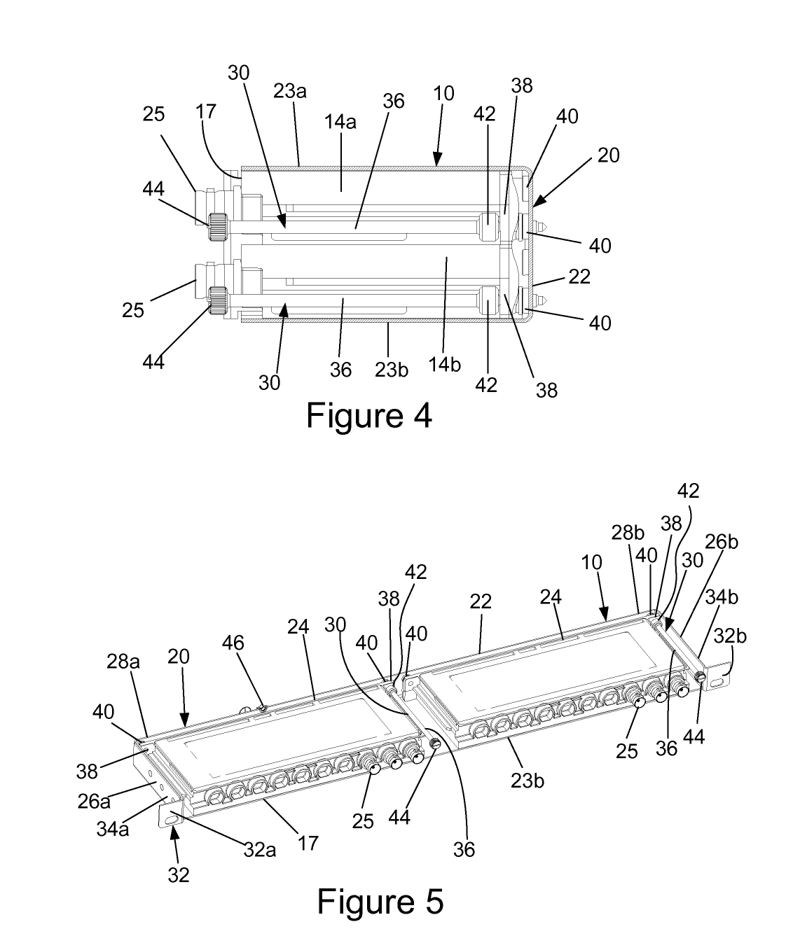

As particularly shown in FIGS. 4 and 5, the module fasteners 30 include fixing screws 36 for coupling flanges 38 extending from back sections of the modules over the back member 22 to corresponding clinch nuts 40 secured to the back member 22. The clinch nuts 40 are preferably press fitted to the back member in positions overlying apertures in the back member 22. The fixing screws 36 are elongate and extend from the back member 22 towards the front side 17 of the modules 14a, 14b. A technician can thereby couple a module 14a, 14b to the back member 22 by performing the following steps:
a. Arranging the module 14a, 14b in one of four predetermined positions in the chassis, where the flanges 38 of the module 14a, 14b overlie corresponding clinch nuts 40;
b. Inserting a first fixing screw through an aperture in a first one of the flanges 38 of the module and screwing the fixing screw 36 into a corresponding one of clinch nuts 40; and
c. Inserting a second fixing screw through an aperture in a second one of the flanges 38 of the module 14a, 14b and screwing the fixing screw 36 into a corresponding one of clinch nuts 40.

The fixing screws 36 include lock nuts 42 which limit the extent to which they can be screwed into the clinch nuts 40. The lock nuts 42 are preferably formed integrally with the fixing screws. The fixing screws 36 preferably at least partially project from the front side 17 of the modules 14a, 14b so that they can be screwed into the clinch nuts 40 externally from the chassis 10. The fixing screws 36 also preferably include tool engaging head 44 shaped for engagement with a screw driver, for example.

The arrangement of the clinch nuts 40 thereby defines the positions at which the modules 14a, 14b can be coupled to the chassis 10.

The module fasteners 30 facilitate inverted coupling of the modules 14a, 14b, about respective horizontal axes, to their respective sections of the back member 22. That is, for example, the clinch nuts 40 are arranged in such a way that the apertures of the flanges 38 of the modules 14a, 14b overlie the clinch nuts 40 when arranged in either a normal or an inverted configuration.

The bracket 20 is made of an electrically conductive material and the electrically conductive fixing screws 36 electrically connect the modules 14a,14b to the bracket 20. The bracket 22 includes an earth connection point 46.

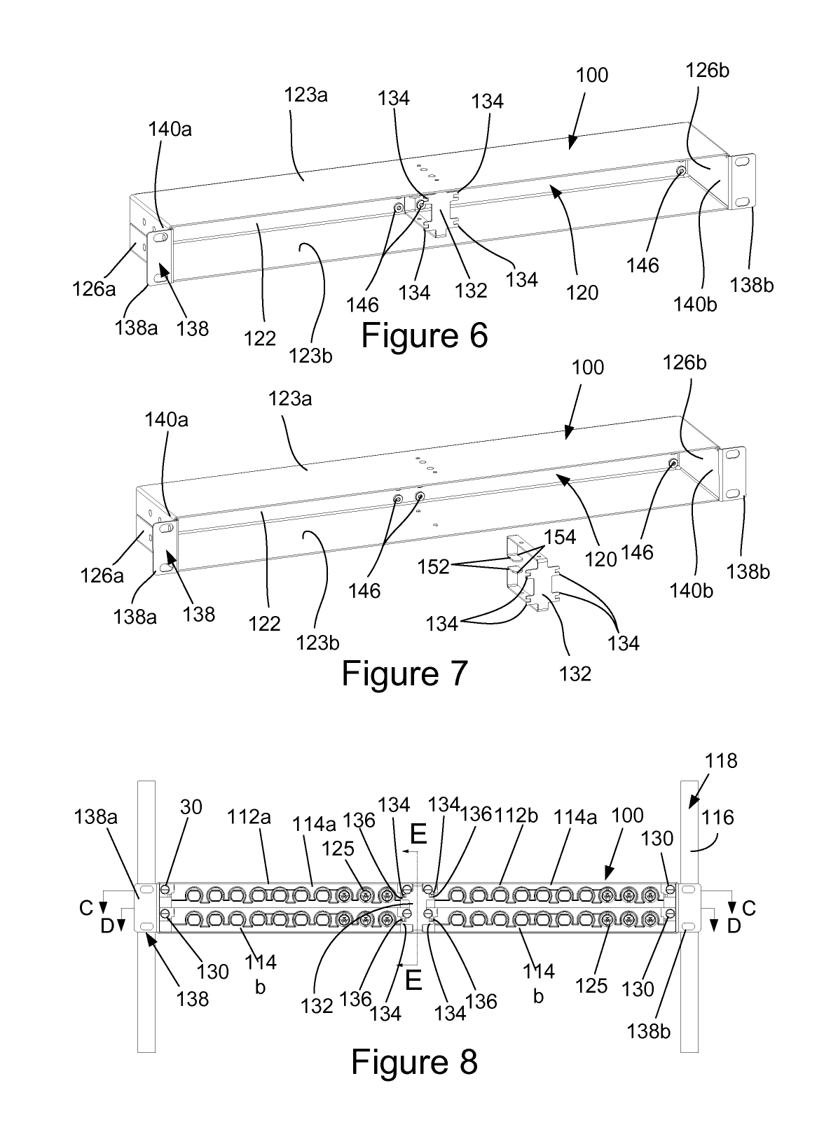

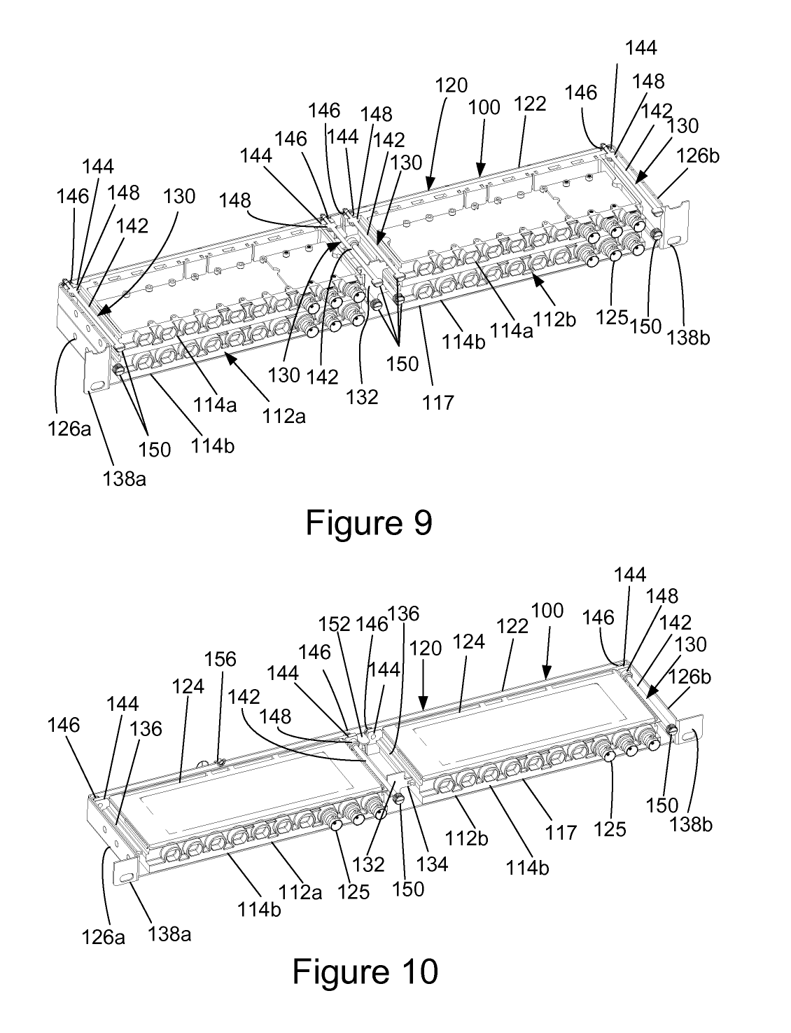

The chassis 100 shown in FIGS. 6 to 12 is used to coupled two stacks 112a, 112b of two telecommunications modules 114a, 114b to a front side 116 of a racking system 118. As particularly shown in FIGS. 9 and 10, the chassis 100 includes a bracket 120 including a back member 122 shaped to extend across back sides 124 of both laterally displaced stacks 112a, 112b of modules 114a, 114b, and side members 126a, 126b extending from opposite ends of the back member 122 towards a front side 117 of the modules 114a, 114b. The chassis 100 also includes module fasteners 130 for coupling respective ones of the modules 114a,114b to respective sections of the back member 122; and a support bracket 132 coupled between the stacks 112a, 112b of modules 114a, 114b. The support bracket includes lateral support members 134 for engaging and at least partially supporting lateral sections 136 of the modules 114a, 114b. The chassis 100 also includes a rack fastener 138 for coupling the side members 126a, 126b of the bracket 120 to the racking system 118. For each stack 112a, 112b, the module fasteners 130 facilitate individual coupling of the modules 114a, 114b to their respective sections of the back member 120 one on top of another.

As particularly shown in FIGS. 6 & 7, the bracket 122 of the chassis 100 also includes top and bottom housing members 123a, 123b extending between common top sides of the back member 120 and the side members 126a, 126b, and common bottom sides of the back member 122 and the side members 126a, 126b respectively. The chassis 100 inhibits transfer of external forces to the stacks 112a, 112b of modules 114a, 114b coupled thereto. Bayonet Neill-Concelman connectors 125 connected to the front side 117 of the modules 114a, 114b are accessible for external connection from the front side 116 of the racking system 118. The modules 114a, 114b are preferably Radio Frequency modules.

The racking system 118 is preferably a 19 inch rack.

As above-mentioned, the support bracket 132 is arranged between the two stacks 112a, 112b of modules 114a, 114b and the lateral support members 134 are shaped to engage the lateral sections 136 of the modules 114a, 114b. The support bracket 132 is preferably coupled between the top and bottom housing members 123a, 123 and arranged towards the front side 117 of the modules 114a, 114b.

In the example shown in FIGS. 8 to 11, the lateral sections 136 of the modules 114a, 114b are lateral rail members 136 extending between front 117 and back 124 sides of the modules 114a, 114b. The lateral support members 134 are “U” shaped projections that open towards the modules 114a, 114b so as to at least partially receive rail members 136 therein. During assembly, the lateral rail members 136 slide along respective lateral support members 134 on route for engagement with their respective sections of the back member 122. The lateral support members thereby assist in locating the modules 114a, 114b for connection to the back member 122. The lateral support members 134 also provide vertical support to the modules 114a, 114b sharing the load of the modules 114a, 114b with the module fasteners 130.

The rack fastener 138 includes two flanges 138a, 138b extending in parallel, in opposite directions, from distal ends 140a, 140b of the side members 126a, 126b of the bracket 120. The flanges 138a, 138b are generally co-planar with the front side 117 of the modules 114a, 114b when the modules 114a, 114b are coupled to the chassis 100.

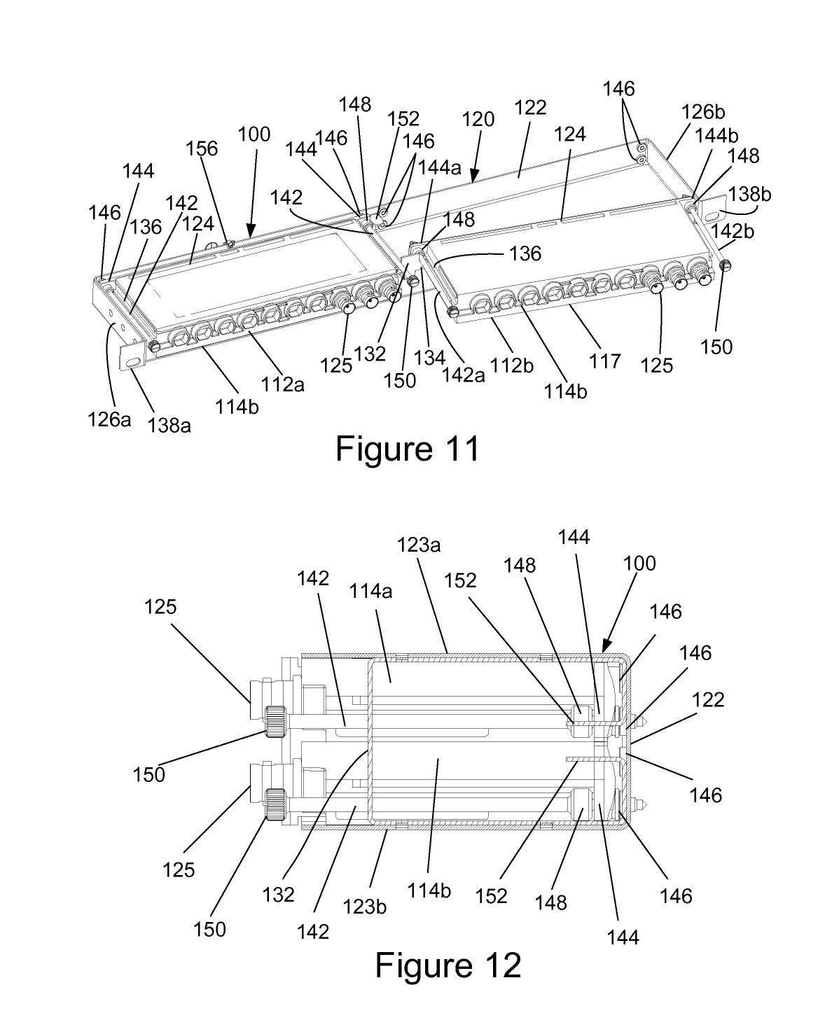

As particularly shown in FIGS. 9 to 12, the module fasteners 130 include fixing screws 142 for coupling flanges 144 extending from back sections of the modules 114a, 114b over the back member 122 to corresponding clinch nuts 146 secured to the back member 122. The clinch nuts 146 are preferably press fitted to the back member in positions overlying apertures in the back member 122. The fixing screws 142 are elongate and extend from the back member 122 towards the front side 117 of the modules 114a, 114b. With reference to FIGS. 10 and 11, a technician can thereby couple a module 114b to the back member 122 by performing the following steps:
a. Arranging the module 14b in front one of four predetermined positions in the chassis 100;
b. Inserting fixing screws 142a, 142b into apertures of the flanges 144a, 144b of the module 114b;
c. Rotating the module 114b about a vertical axis so that the innermost flange 144a of the module 114b extends behind a corresponding lateral support members 134 of the support bracket 132;
d. Resting the innermost lateral rail member 136 of the module 114b in a corresponding lateral support member 134 and resting the fixing screw 142a on top of the corresponding lateral support member 134;
e. Forcing the module 114b into the chassis 100 so that the flanges 144a, 144b overlie corresponding clinch nuts 146; and
f. Screwing the fixing screw 142a, 142b into a corresponding clinch nuts 146.

As particularly shown in FIG. 12, the fixing screws 142 include lock nuts 148 which limit the extent to which they can be screwed into the clinch nuts 146. The lock nuts 148 are preferably formed integrally with the fixing screws 142. The fixing screws 142 preferably at least partially project from the front side 117 of the modules 114a, 114b so that they can be screwed into the clinch nuts 146 externally from the chassis 100. The fixing screws 142 also preferably include tool engaging head 150 shaped for engagement with a screw driver, for example.

The support bracket 132 also includes guide members 152 for locating the fixing screws 142 of the module fasteners 130 in positions for engagement with corresponding clinch nuts 146. The guide members 152 include convex articular guiding surfaces 154 for guiding the fixing screws 142 into positions for mating with the clinch nuts 146.

The arrangement of the clinch nuts 146 thereby defines the positions at which the modules 114a, 114b can be coupled to the chassis 100.

The module fasteners 130 facilitate inverted coupling of the modules 114a, 114b, about respective horizontal axes, to their respective sections of the back member 122. That is, for example, the clinch nuts 146 are arranged in such a way that the apertures of the flanges 144 of the modules 114a, 114b overlie the clinch nuts 146 when arranged in either configuration.

The bracket 120 is made of an electrically conductive material and the electrically conductive fixing screws 142 electrically connect the modules 114a,114b to the bracket 120. The bracket 122 includes an earth connection point 156.

While we have shown and described specific embodiments of the present invention, further modifications and improvements will occur to those skilled in the art. We desire it to be understood, therefore, that this invention is not limited to the particular forms shown and we intend in the append claims to cover all modifications that do not depart from the spirit and scope of this invention.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge in Australia.

### LIST OF PARTS

10 Chassis
12a, 12b Stack of modules
14a, 14b Telecommunication modules
16 Front side of racking system
17 Front side of modules
18 Racking system
20 Bracket
22 Back member
24 Back side of modules
25 Bayonet Neill-Concelman connector
26a, 26b Side members
28a, 28b End section of back member
30 Module fastener
32 Rack fastener
32a, 32b Flange
34a, 34b Distal end of side member
36 Fixing screw
38 Flange
40 Clinch nut
42 Lock nut
44 Tool engaging head
46 Earth connection point
100 Chassis
112a, 112b Stack of modules
114a, 114b Telecommunication modules
116 Front side of racking system
117 Front side of modules
118 Racking system
120 Bracket
122 Back member
123a Top housing member
123b Bottom housing member
124 Back side of modules
125 Bayonet Neill-Concelman connector
126a, 126b Side members
130 Module fastener
132 Support bracket
134 Lateral support member
136 Lateral section of module
138 Rack fastener
138a, 138b Flange
140 Distal end of side member
142, 142a, 142b Fixing screw
144, 144a, 144b Flange
146 Clinch nut
148 Lock nut
150 Tool engaging head
152 Guide member
154 Convex articular surface of guide member
156 Earth connection point

1. A chassis for coupling a stack of two or more telecommunications modules to a front side of a racking system, comprising:
(a) a bracket having a back member shaped to extend across a back side of said stack of modules, and side members extending from opposite end sections of the back member towards a front side of the modules;
(b) module fasteners for coupling respective ones of said modules to respective sections of the back member; and
(c) a rack fastener for coupling the bracket to the racking system,
wherein said module fasteners facilitate individual stacking of the modules to said respective sections of the back member one on top of another.

2. The chassis claimed in claim 1, wherein the rack fastener includes two flanges extending in parallel, in opposite directions, from distal ends of the side members of the bracket.

3. The chassis claimed in claim 2, wherein the flanges are generally co-planar with the front side of the modules when the modules are coupled to the chassis.

4. The chassis claimed in claim 1, wherein the module fasteners include fixing screws for coupling flanges extending from back sections of the modules over the back member to corresponding clinch nuts secured to the back member.

5. The chassis claimed in claim 4, wherein the fixing screws are elongate and extend from the back member towards the front side of the modules.

6. The chassis claimed in claim 1, wherein the module fasteners facilitate inverted coupling of the modules, about respective horizontal axes, to said respective sections of the back member.

7. The chassis claimed in claim 1, wherein the bracket is made of an electrically conductive material and the module fasteners electrically connect the modules to the bracket.

8. The chassis claimed in claim 7, wherein the bracket includes an earth connection point.

9. The chassis claimed in claim 1, wherein the bracket includes top and bottom housing members extending between common top sides of the back member and the side members, and common bottom sides of the back member and the side members respectively.

10. The chassis claimed in claim 1, wherein the chassis inhibits transfer of external forces to said stack of modules coupled thereto.

11. The chassis claimed in claim 1, wherein Bayonet Neill-Concelman connectors connected to the front side of the modules are accessible for connection from the front side of the racking system.

12. The chassis claimed in claim 1, wherein the modules are Radio Frequency modules.

13. A chassis for coupling two stacks of two or more telecommunications modules to a front side of a racking system, comprising:
(a) a bracket having a back member shaped to extend across back sides of both laterally displaced stacks of modules, and side members extending from opposite end sections of the back member towards a front side of the modules;
(b) module fasteners for coupling respective ones of said modules to respective sections of the back member; and
(c) a rack fastener for coupling the side members of the bracket to the racking system,
wherein for each stack of said stacks, said module fasteners facilitate individual stacking of the modules to said respective sections of the back member one on top of another.

14. A chassis for coupling two stacks of two or more telecommunications modules to a front side of a racking system, comprising:
(a) a bracket having a back member shaped to extend across back sides of both laterally displaced stacks of modules, and side members extending from opposite ends of the back member towards a front side of the modules;
(b) module fasteners for coupling respective ones of said modules to respective sections of the back member;
(c) a support bracket coupled between the stacks of modules, including lateral support members for engaging and at least partially supporting lateral sections of the modules; and
(d) a rack fastener for coupling distal ends of the side members of the bracket to the racking system,
wherein for each stack of said stacks, said module fasteners facilitate individual coupling of the modules to said respective sections of the back member one on top of another.

15. The chassis claimed in claim 14, wherein the lateral support members are shaped to at least partially receive lateral rail members extending between front and back sides of the modules.

16. The chassis claimed in claim 15, wherein the lateral support members locate modules in positions for engagement with said respective sections of the back member.

17. The chassis claimed in claim 14, wherein the lateral support members are generally “U” shaped.

18. The chassis claimed in claim 14, wherein the support bracket is coupled between top and bottom housing members extending between common top sides of the back member and the side members, and common bottom sides of the back member and the side members respectively.

19. The chassis claimed in claim 14, wherein the module fasteners include fixing screws for coupling flanges extending from back sections of modules over the back member to corresponding clinch nuts secured to the back member.

20. The chassis claimed in claim 19, wherein the fixing screws are elongate and extend from the back member towards the front side of the modules.

21. The chassis claimed in claim 14, wherein the module fasteners facilitate inverted coupling of the modules, about respective horizontal axes, to said respective sections of the back member.

22. The chassis claimed in claim 19, wherein the support bracket includes guide members for locating the fixing screws of the module fasteners in positions for engagement with corresponding clinch nuts.

23. The chassis claimed in claim 22, wherein the guide members include convex guiding surfaces.

24. The chassis claimed in claim 14, wherein the rack fastener includes two flanges extending in parallel, in opposite directions, from distal ends of the side members of the bracket.

25. The chassis claimed in claim 24, wherein the flanges are generally co-planar with the front side of the modules when the modules are coupled to the chassis.

26. The chassis claimed in claim 14, wherein the bracket is made of an electrically conductive material and the module fasteners electrically connect the modules to the bracket.

27. The chassis claimed in claim 26, wherein the bracket includes an earth connection point.

28. The chassis claimed in claim 14, wherein the chassis inhibits transfer of external forces to said stacks of modules when coupled thereto.

29. The chassis claimed in claim 14, wherein Bayonet Neill-Concelman connectors connected to the front side of the modules are accessible for connection from the front side of the racking system.

30. The chassis claimed in claim 14, wherein the modules are Radio Frequency modules.
